(19) United States
(12) Patent Application Publication
(10) Pub. No.: US 2007/0068138 A1
(43) Pub. Date: Mar. 29, 2007

(54) Rocket vehicle and engine

(76) Inventor: Geoffrey T. Sheerin, Orillia (CA)

Correspondence Address: FRANK C. NICHOLAS;CARDINAL LAW GROUP, Suite 2000, 1603 Orrington Avenue, Evanston, IL, 60201, US

(21) Appl. No.: 11/436,138

(22) Filed: May 17, 2006

Related U.S. Application Data
(60) Provisional application No. 60/681,699, filed on May 17, 2005.

(51) Int. Cl. F02K 9/42

(52) U.S. Cl. 60/257

(57) ABSTRACT

A rocket vehicle and engine including a manned suborbital rocket including a nose cone; a crew cabin operably connected to the nose cone; and a rocket engine employing the German A-4 (V-2) design. The rocket engine includes an injector; a combustion chamber operably connected to the injector; and a nozzle operably connected to the combustion chamber, the nozzle having an ablative liner. The injector, the combustion chamber, and the nozzle employ a German A-4 (V-2) rocket engine design.

### CROSS-REFERENCE TO RELATED APPLICATIONS

This application claims priority to U.S. Provisional Application No. 60/681,699, filed May 17, 2005, and incorporated in its entirety herein by reference.

### BACKGROUND OF INVENTION

This invention relates to the field of rocket vehicle design and, more particularly, to a manned spacecraft booster for suborbital space flight.

During WWII the German army developed the A-4 rocket that is commonly known as the V-2 in the history books. This rocket was the first item built by humans that left the earth and journeyed into space. During the war the Germans manufactured over 6000 A-4 rockets and managed to launch almost 3000 of these as missiles. In order to achieve this technical feat they needed to develop the first airframe designed to fly at greater than mach 4. This required hundreds of hours of wind tunnel work worth millions in today's dollars. One of the drivers to this airframe design was the requirement that the A-4 be portable and drive through existing road and tunnels.

Also, they had to develop a liquid propellant rocket engine of 25 metric tons of thrust. This engine had propellants forced into the combustion chamber by powerful pumps run by a turbine. These pumps would draw propellants from a set of aluminum tanks that were located inside an outer airframe structure providing for double wall aircraft like containment of the tanks. Further they needed to develop guidance and control systems that were self contained and could steer the rocket with relative accuracy in order to hit the target. The guidance system use vacuum tubes and mechanical gyros to send steering commands to a set of graphite jet vanes that directed engine exhaust to steer. Also on each of the fins were small aerodynamic trim tabs that would help with roll and yaw of the vehicle.

Since the A-4 was a missile the systems were when used for their final purpose would be destroyed on the other end of the trajectory. It is therefore not obvious to those skilled in the arts that the A-4 could be turned into a reusable design. The clues to this are hidden in the details of the A-4 story which if studied show a rocket that was able to be fired a number of times and due to its flight profile could carry humans into space and become fully recoverable.

The A-4 main engines were run dozens of times on the ground test stand with now apparent wear to the system. Also complete A-4 rockets were test fired for at least one flight on the ground test stand before being place on the launch pad to make an actual flight into space. The guidance systems of the day were heavy with computer checkout system all but none existent. Even so it would only take 12 people 1 hour to prepare and launch an A-4 rocket. They could do this from any remote location since the A-4 was transported by road or rail and launch from a small portable launch pad. It was not uncommon to find A-4 rocket launching from within a forest rising out through the trees.

After WWII the US and Russia captured various A-4 rocket components and bringing them back to there respective countries for study and launch. The US assembled and flew 60 A-4 rockets out of White Sands Missile Range NM. On these launches the war head was removed and in it place were various scientific instruments. These instruments would not only measure the space environment but monitor various rocket parameters and performance. These rocket vehicle measurements show that the launch environment would lend itself to manned spaceflight should that opportunity have been pursued with the A-4.

This invention also relates to the field of liquid propellant rocket engines and more particularly, to modifications to the existing V-2 liquid propellant rocket engine design.

During WWII, the German army developed the A-4 rocket that is commonly known as the V-2 in the history books. This rocket was the first item built by humans that left the earth and journeyed into space. To achieve this technical accomplishment the Germans had to develop a liquid propellant rocket engine that produced 25 metric tons of thrust.

A liquid propellant rocket engine provides thrust by burning an oxidizer and fuel in a combustion chamber resulting in a high pressure high temperature low velocity gas. This gas passes through a nozzle that covert it to a lower pressure and temperature but very high velocity gas. It will be appreciated by those skilled in the art that building a combustion chamber and nozzle that will survive the severe heating and gas velocity is a complicated and expensive task that requires hundreds of test to confirm operation before a first flight.

In the case of the A-4 engine the oxidizer used is liquid oxygen (LOX) and the fuel is ethyl alcohol. Both of these propellants are injected into the combustion chamber through a variety of holes and simplex type nozzles that help atomize and mix the propellant for efficient ignition and combustion.

As will be appreciated by those skilled in the art, developing an injector system for such a powerful engine is a complicated and expensive task that requires hundreds of bums on a ground based static test stand that will prove the engines performance before any flights can be achieved.

Early in the development of the A-4 rocket some smaller rocket engines with just under 1.4 metric tons of thrust were developed. These used injectors were shaped like a large cup with the LOX injector of a design similar to a showerhead at the base of the cup and the alcohol injectors distributed in five rows around the walls of the cup. All the injectors were installed by threads and therefore could be remove for inspection later after running on the ground static test stand. In the small 1.4 metric ton thrust engine the cup exited into a single combustion chamber and then into a nozzle. The Germans found very good success in using this burner cup in both combustion efficiency and material use. As will be appreciated to those skilled in the art, one cannot just scale up a rocket engine injector to get increased thrust. The dimensions of the injector holes and the dynamics of the propellant mixing change radically with increase in scale and the engine would not perform correctly and in fact would be useless.

Since the German Army was in the middle of WWII, they did not have the time or the money to develop a new injector system that would provide the 25 tons of thrust required. To solve this problem the decided to incorporate 18 of the single burner cups onto the top end of a common combustion chamber resulting in a larger single nozzle engine of the 25 metric tons thrust required. This design worked well and significantly shortened the injector design time required. All that was left now was to prove out the cooling and nozzle design and propellant feed systems for the engine.

The first 200 engines for the A-4 were of a two part design. The injector assembly with 18 burner cups was manufactured of aluminum with brass and bronze injectors in the burner cups. This injector was constructed of two domes that formed the top end of the spherical combustion chamber with a large flange onto which the chamber and nozzle would attach. Both the domes would form a regenerative cooling system that prevented the aluminum dome walls from burning through due to the high heat of combustions. Alcohol fuel would pass from the combustion chamber and nozzle to the aluminum injector through holes around the flange. It would then circulate between the two domes to cool the aluminum wall and pre-heat the fuel on its way to the combustion chamber. After passing through the regenerative cooling jacket, the alcohol would pass through a central valve and then move into the top of the injector where it would pass into the burner cups injector holes.

The combustions chamber and nozzle were manufactured from steel with a large bolt flange to fasten the chamber and nozzle to the aluminum injector assembly. This chamber and nozzle were also of double wall construction to provide a path for the alcohol propellant to circulate from the exit of the nozzle up to the injector flange. As will be appreciated by those skilled in the art higher feed pressures are required on the alcohol side to overcome the increased resistance to the flow of alcohol through the narrow chamber wall on its way to the injector. This increase in pressure must be compensated by the pump and turbine system. Regenerative cooling was found to be inadequate by itself and would lead to intermittent burn through of the early test stand engines. To enhance cooling some of the alcohol was diverted from the injectors and fed into a film cooling system. This film cooling system consisted of a set of four rings containing small injector holes. Alcohol was introduced to these holes where it would evaporate but not burn with the chamber oxygen. This would result in a cool film of alcohol vapor between the wall and the hot combustion chamber gases. By using this regenerative cooling with film cooling the Germans were able to prevent all further burn through of the combustion chamber and nozzle system. The disadvantage to the film cooling is that up to 16% of the alcohol would not go to propulsion but be dumped overboard as film cooling reducing the overall efficiency of the rocket vehicle.

These two part A-4 engine were successful during test and flight but for mass production it was decided to change to an all steel construction for the entire engine and nozzle that would allow the complete unit to be welded together thus removing the large injector/chamber flange from the design. Also, in the late 30's and early 40's aluminum welding was still difficult to do with the welding machines of the day. Changing to an all steel injector would make for easier construction during the production of the A-4.

To force the propellants from the tanks and into the engine required the development of light weight pumps that were driven by a turbine. The pumps were of a similar design to that found in fire pumps and provided the high flow high pressure to force the alcohol through the regenerative cooling system and the LOX directly into the top of each individual burner cup. The design of the A-4 rocket engine required that its combustion chamber run at 15 atmosphere pressure (215 psi) to provide the required 25 metric tons of thrust. This required the pumps on the A-4 to deliver the propellants at two atmospheres above combustion chamber pressure. To do this the pressure losses of the entire plumbing system needed to be overcome before reaching the injectors. The pumps would therefore be required to deliver up to 24 atmospheres (360 psi).

In order to power the pumps with little weight, a turbine that ran on steam produced from the decomposition of hydrogen peroxide was used. This pump system was very complex and as will be appreciated by those skilled in the art would be expensive and take a long time to develop. Indeed, turbopumps can require up to 80% of the money and time required in the development of a rocket engine system. The A-4 rocket engine combustion chamber pressure is very low in comparison to the designs that followed it. Today pressures of up to 75 atmospheres are more common with pumps that can deliver many times that pressure to the engine system.

One other feature of the A-4 engine developed by the Germans was the pre-stage start sequence. It was found that delivery of the propellants at full operating pressure to the combustion chamber would some time result in explosions of the engine on the test stand. To those skilled in the art this is called a hard start and is caused by to much propellant accumulating in the combustion chamber before ignition is achieved. To get around this problem the Germans kept the A-4 turbo pumps off and let the propellants feed by gravity to the combustion chamber where it was ignited using a pyrotechnic device that created high temperature sparks. This low pressure propellant feed and combustions was called pre-stage. Only after the successful combustion (pilot light) was achieved then the turbo pumps were activated and brought the propellant feed pressure up to that required for full thrust.

By the time WWII was over, the Germans had developed and were manufacturing in large quantity the 18 burner cup all steel engine. Up to 6000 rockets were manufactured and 3000 were flown using this engine during the war.

### SUMMARY OF THE INVENTION

One aspect of the present invention relates to a rocket vehicle for suborbital manned spaceflights. A manned suborbital rocket that is based on the German A-4 (V-2) for the purpose of carrying paying passengers into suborbital space. The changes to the A-4 design are as follows:
The tail section is identical in design and function to the A-4 with modern materials and equipment in place of the 1940's design. The engine is identical with the turbopumps removed and in its place two lines directly going to valves that turn on propellants to the engine combustion chamber. Just above the tail section is the parachute and airbrake section that is not found on the original A-4. Above this section are the propellant tanks that have walls integral to the outside of the rocket vehicle. Inside the tanks is helium gas storage tanks that contain the high pressure gas needed to pressurize the tanks and force the propellants into the engine combustion chamber. On top of the propellant tanks is the crew cabin that carries the astronauts with guidance equipment life-support equipment and recovery equipment. Attached on top of the crew cabin is the nose cone shroud complete with escape tower and escape rocket engines. When all the components are assembled they form an aerodynamic shape identical to the German A-4 but extended in length by two calibers (diameters) to incorporate an escape tower for the crew cabin.

Accordingly, one aspect of the present invention is to use the A-4 rocket engine and jet vane design in a recoverably suborbital manned space craft. A related aspect is to remove the turbo pumps and replace a gas pressure system to force propellants into the combustion chamber. A further related aspect is to construct single wall propellant tanks where the tank wall is also the outside wall of the rocket vehicle with the same diameter (caliber) as the original A-4 rocket.

Another aspect is to use the overall airframe design and its advantage for road and rail travel. A further related aspect is to make the nose cone removable during flight to help in recovery of the entire vehicle. A further related aspect is to provide a parachute deceleration system that will recover the rocket booster with propellant tank. This parachute recovery system has a door system that doubles as air brakes to provide for deceleration. Separate parachutes are used for the crew cabin and nosecone escape system.

Another aspect of the present invention is to provide a modern digital guidance and control system that is a fraction of the weight to the original A-4 design.

Another aspect of the present invention is to remove the warhead design and weight from the original A-4 design and replace it with a crew cabin that can carry humans on a suborbital space flight. A further related aspect is to increase the length of the airframe by two caliber to accommodate an escape tower that would pull a crew cabin to safety should the rocket have problems at launch or during flight.

According to the present invention, the foregoing and other objects are obtained by providing an airframe with identical diameter (caliber) to the original A-4 with identical tail section aerodynamic and controls. The airframe is increased in length by two calibers in order to make use room for escape and parachute recovery systems. The tails section is identical in manufacture and operation to the original A-4 rocket. The propellant tanks are different from the A-4 in the fact they have a single wall that is also the outer wall of the booster section. A nose cone is of the same aerodynamic shape found on the A-4 but that is where the similarity ends. The nose cone is a shroud that covers the crew cabin and escape tower system. This nose cone separates from the crew cabin when in space or just after an abort during the flight. As with all the other parts of the rocket the nose cone is recovered for reuse.

Yet another aspect of the present invention relates to a rocket engine thrust chamber and injector assembly. The use of the A-4 (V-2) rocket engine for a manned suborbital booster using a pressure gas feed system. A metal injector head with mounting flange around which a manifold is found to provide for fuel distribution to the injector domes. An ablative type combustion chamber and nozzle bolted to the injector flange. The engine turbo pump usually found in the original V-2 is removed and in its place is a pressure gas feed system that forces the propellants from the main tanks. Using this removable nozzle allows for easy access to the brass injectors nozzles that can be removed individually and replace as required. Due to recovery of the vehicle the rocket motor is reusable with installation of a new chamber nozzle system.

Accordingly, one aspect is of the present invention is to use the original A-4 engine with its safe low pressure combustion and pre-stage start system for propulsion of a manned vehicle that will fly a suborbital trajectory. A related aspect is to provide an ablative cooled combustion chamber and nozzle that will remove the required regenerative cooling pressure drop and fuel required for film cooling.

A further aspect is to manufacture an aluminum injector dome with fuel manifold around the injector flange to provide for regenerative cooling of the injector and removing the required fuel supply from a regenerative chamber and nozzle unit. A further related aspect is to remove the turbo pump fuel delivery system and replace it with a tank pressurization system eliminating all the complexity and expense of the turbo pump system. The A-4 is the only high thrust low chamber pressure engine to have flown thousands of times. This low chamber pressure allows for removal of the pumps and use of new modern light weight tank systems.

According to the present invention, the foregoing and other objects are obtained by providing an aluminum injector with 18 burner cups mounted on a double wall injector dome. Preferably, a fuel manifold surrounds the perimeter of the injector dome above the main flange used to mount the injector to the combustion chamber and nozzle. Fuel under the pressure of gas in the fuel tanks enters this manifold and passes through the regenerative cooled dome and then onto the injectors system. Liquid Oxygen is fed under gas pressure in the oxidizer tank enters the LOX manifold and distributed to each of the 18 burner cups on the head of the engine. The combustion chamber and nozzle are constructed of ablative material well known to those skilled in the art having a profile that forms the same internal shape as found in the original steel A-4 engine. The Ablative liner has 12 sets of balancing jets mounted in the wall of the combustion chamber. Each of the set is comprised of three groups of four hole injectors drilled into the ablative wall. These holes communicate from the combustion chamber into a manifold attached on the outside wall of the ablative nozzle. This wall is connected to the injector alcohol manifold by two pipes that bring alcohol down from the main injector manifold.

In one embodiment, a removable regenerative cooled nozzle is constructed of metal providing cooling for the combustion chamber and nozzle. This metal nozzle has both a manifold at the exit of the nozzle and top flange of the combustion chamber to allow fuel to pass into and out of the regenerative cooled nozzle.

Additional objects, advantages and novel features of the invention will be set forth in part in the description which follows, and in part will become apparent to those skilled in the art upon an examination of the following, or may be learned by practice of the invention.

### BRIEF DESCRIPTION OF THE DRAWINGS

In the accompanying drawings, which form a part of this specification and which are to be read in conjunction therewith and in which like reference numerals are used to indicate like parts in the various views.

FIG. 1 is a perspective view showing the original A-4 (V-2) rocket.

FIG. 2 is a diagram showing the normal flight profile of the A-4 (V-2) rocket.

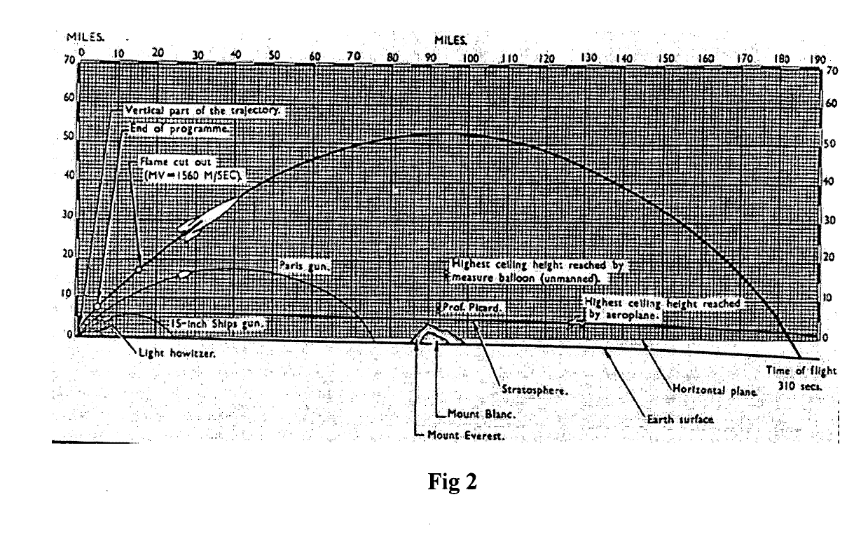

FIG. 3 is a side elevation cutaway showing the main components of the present invention.

FIG. 4 shows the propellant feed system for the present invention.

FIG. 5 is a diagram showing the normal flight profile of the rocket vehicle invention.

FIG. 6 is a perspective view of the crew cabin and escape tower system.

FIG. 7 is a picture of the original A-4 aluminum injector steel nozzle liquid propellant rocket engine.

FIG. 8 is a cutaway view of the original A-4 all steel production rocket engine.

FIG. 9 is a perspective view of the present invention showing the aluminum injector and ablative nozzle.

FIG. 10 is a cross-sectional view of the invention showing the flange connections ablative line thickness and burner cup configuration at the injector/combustion chamber attachment.

FIG. 11 is a cross-section view of the invention showing the flow of fuel and oxidizer.

FIG. 12 is a schematic showing the pressure propellant feed system used to force propellants into the engine.

FIG. 13 is an exploded view of the injector assembly.

FIG. 14 is a cross section of the ablative nozzle showing the balancing jets.

### DETAILED DESCRIPTION OF PREFERRED EMBODIMENTS

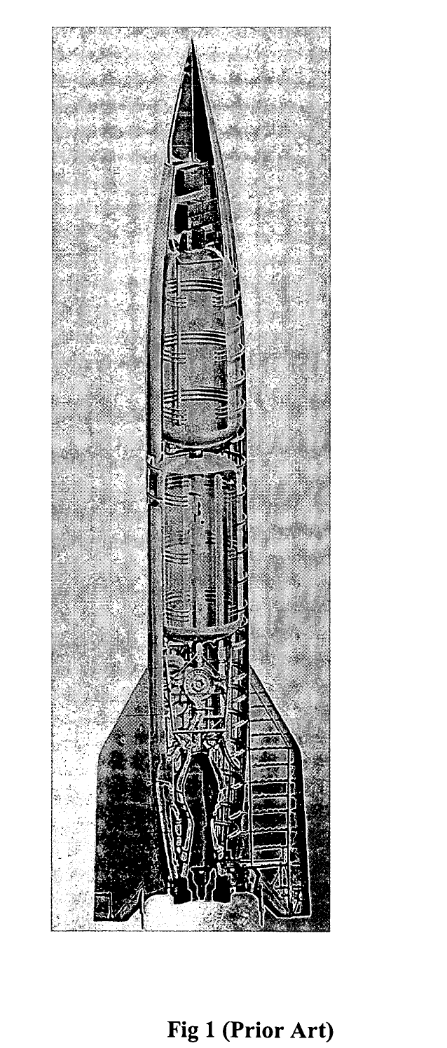

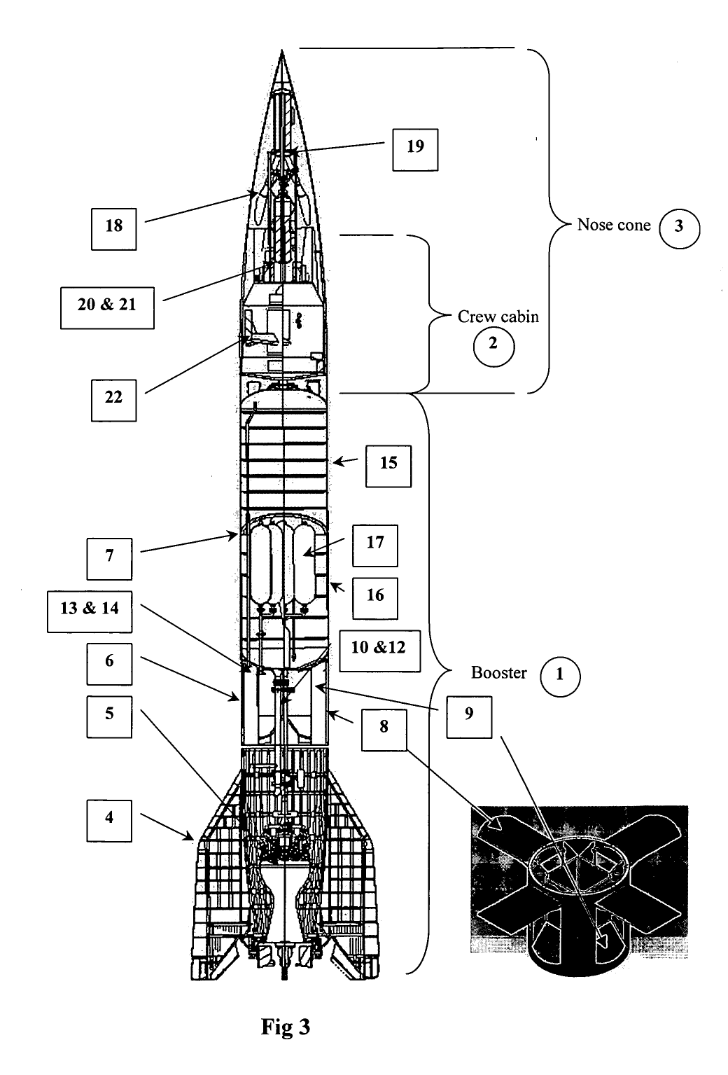

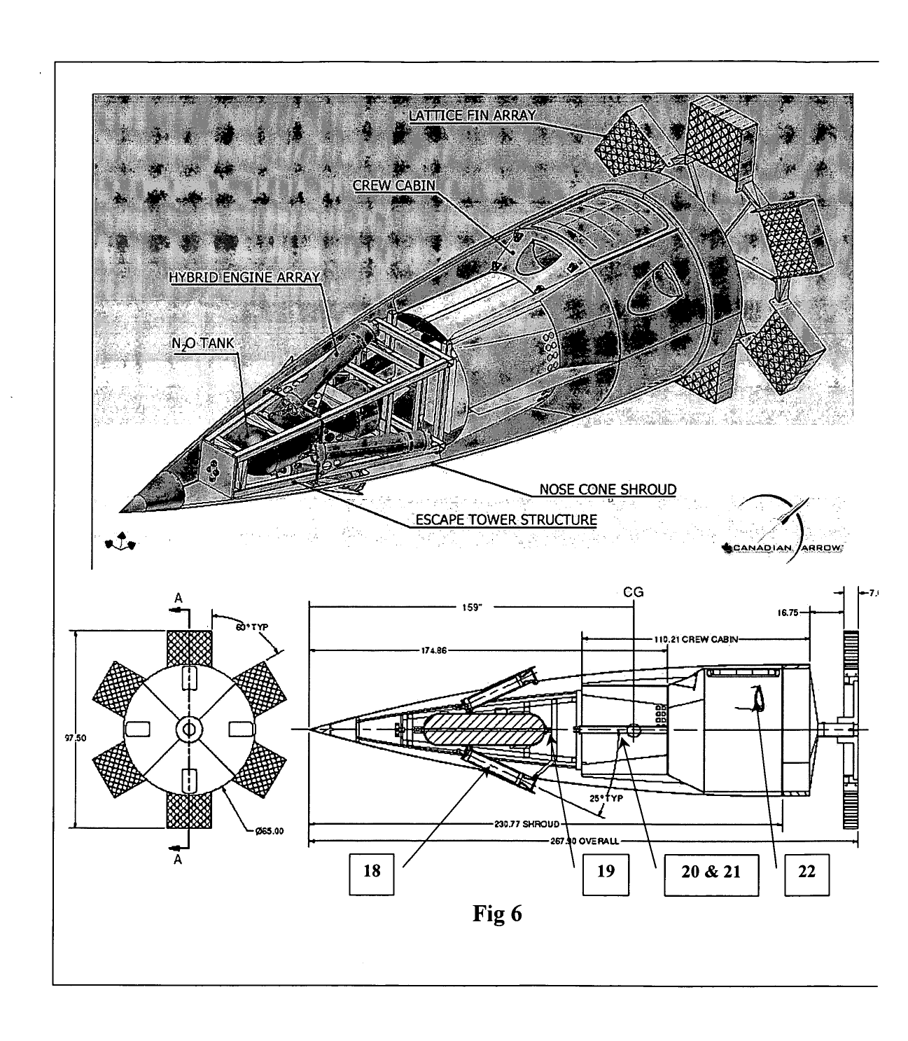

A manned suborbital rocket vehicle as shown in FIGS. 3 and 6 and is in shape and form very similar to the original A-4 as shown in FIG. 1. The rocket has three major components the booster section 1 crew cabin section 2 and the nosecone shroud 3.

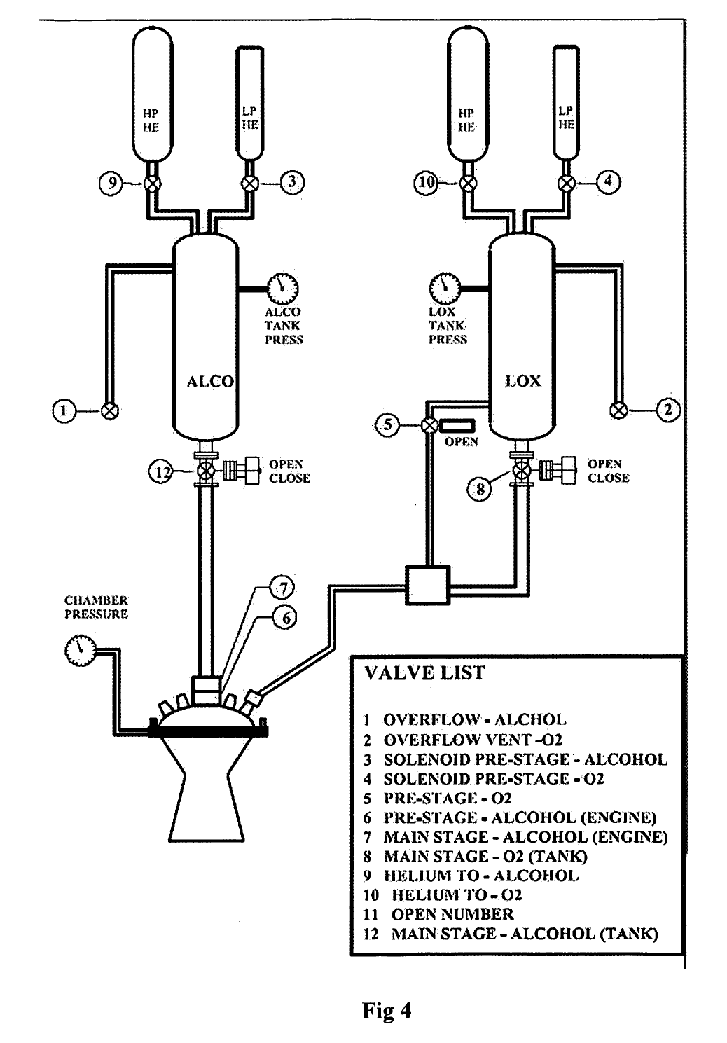

The booster section is divided into four major sections as follows the tail section 4, the engine and thrust frame section 5, the parachute section 6 and the tank section 7. The tail section is of identical design to the original A-4 as shown in FIG. 1. The engine and thrust 5 frame are also similar in design to that found on the original A-4 rocket. The parachute section 6 contains four airbrakes 7 used to decelerate the booster on reentry until it reaches the correct speed for main parachute deployment. The main parachutes 8 are located just underneath the air brakes and get deployed below 12,000 ft. The parachute section 6 outside skin forms part of the outer wall of the booster with the interior partitions by 4 walls 9 two parallel to each other and opposed at 90 degrees to form a cross H structure. Through this structure passes propellant lines 10 and 12 that transport propellant to the main engine. Also contained in this section is the booster guidance and control system 13 and 14. This guidance system keeps the booster stable during ascent and decent until parachutes are deployed. Above this section is the tank section 7 that contains the Liquid Oxygen tank 15 and Alcohol tank 16. Inside the Alcohol tank 16 is contained the Helium pressuring tanks 17 that force the propellant into the engine through a system shown in FIG. 4. The outside of the tank walls are also the wall of the booster vehicle.

The crew cabin 2 and nose cone 3 are shown in FIG. 6 and are designed to be separated during flight and recovered separately. The nose cone 3 contains the escape rockets 18 and tower structure 19. Also in the nose cone are the parachutes required to recover the unit after reentry. The crew cabin 2 contains the three astronaut crew and all systems required for a safe manned spaceflight. As shown in FIG. 6 the main parachute 20 and backup parachute 21 are housed in a cylindrical unit on top of the cabin section. Each astronaut can see outside the crew cabin through three windows 22.

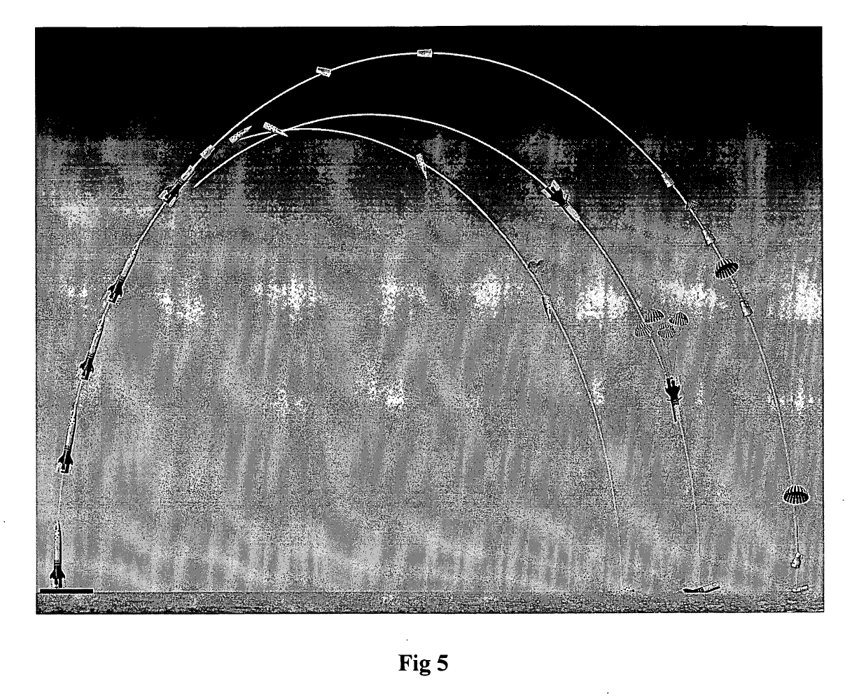

The flight profile as shown in FIG. 5 has the following steps and timing to the flight. This section describes the events sequence in a typical suborbital rocket flight. The figure following the test shows the major events in the flight sequence. Each of the flight events is preceded by a detailed description and mission elapse time that the event should occur.

T+00:00:00 Lift-Off

The Rocket lifts of the offshore launch pad and the on-board mission clock is started.

T+00:00:14 Aerodynamic Stability

The Rocket is now traveling fast enough so the tail fins provide aerodynamic stability. Should the guidance system commands fail at this point the Rocket should continue upward flight without danger to the crew. (Unlike the German A-4 (V-2) the rocket invention has parachutes on the booster and could recover the booster intact if abort is at a high enough altitude).

T+00:00:30 Supersonic Transition

The rocket passes through the speed of sound (Mach1)

T+00:00:35 Max Q

This point is where the Rocket experiences maximum dynamic pressure. This is where the astronauts will experience maximum vibration. Cabin pressure should be maintained at 7.5 pounds/square inch. Failure to maintain proper cabin pressure will require an abort.

T+00:01:09 Main Engine Cut Off (MECO) and Crew Cabin Separation

The Rocket booster main engine shuts down, ending powered flight. Simultaneously, the crew cabin with the escape tower still attached separates from the booster. Five seconds after the escape tower is separated from the crew cabin. The astronauts can perform the crew cabin and escape tower separation manually by pulling the SEP CABIN and JETT TOWER override rings, if required. (The tower is recovered later by parachute into the water.

T+00:01:10 Turnaround

Using the automatic stabilization & Control System (ASCS), the spacecraft turns in pitch so that it is flying with its nose pointing to the earth below and the heat-shield pointing in the direction of travel. This is an automatic maneuver and the astronauts may elect to perform this manually.

T+00:01:20 Attitude Control Tests

This time is the start of manual operation of the attitude control system. The cold gas Jets are used in proportional and direct on of digital control. During later flights of the crew cabin portion this portion will be used to orient the crew cabin for the best views of earth and sky.

T+00:03:31 Maximum Altitude

On a typical flight of this rocket invention the maximum altitudes is just over 70 miles and is the turning point and start of decent towards the atmosphere and re-entry.

T+00:05:12 0.05 G

When the Automatic stabilization & control system (ASCS) detects the beginning of reentry, it will initiate a 10⁰/second roll. This maneuver makes the spacecraft more stable during reentry. The astronauts can perform this maneuver manually.

T+00:05:28 Maximum G

At this point the crew cabin is experiencing the maximum deceleration of 5.59 g. The heat shield temperature will have reached 550 C maximum.

T+00:06:34 Drogue Parachute Deploy

At about 35,000 feet in altitude, the drogue parachute should deploy, slowing the descent rate to about 360 ft/sec. In addition to slowing the descent rate, the drogue parachute helps stabilize the spacecraft. The astronauts can deploy the chute by pulling the DROGUE DEP pull rings. The ground control can also send a command to deploy this chute. (There is also a backup drogue onboard)

T+00:06:45 Snorkel Deploy

At about 18,000 feet, the fresh air snorkel deploys. Simultaneously, the Environmental Control System (ECS) switches to the emergency cabin air rate. These actions help cool the spacecraft environment after the heating effects of reentry.

T+00:07:09 Main Parachute Deployment

At about 15,000 feet, the 64 ft main parachutes deploy, slowing the descent rate to 22 ft/sec. The astronauts can deploy the 64 ft main chutes by pulling the MAIN CHUTE pull ring. The ground control can also send a command to deploy these chutes.

T+00:15:30 Splashdown and Rescue Aids Deploy

After landing, buoyancy floats are inflated and the cabin floats on its side with cabin hatch up waiting for recovery. There should also be a booster and escape tower waiting to be recovered having splashed down in the same area minutes before.

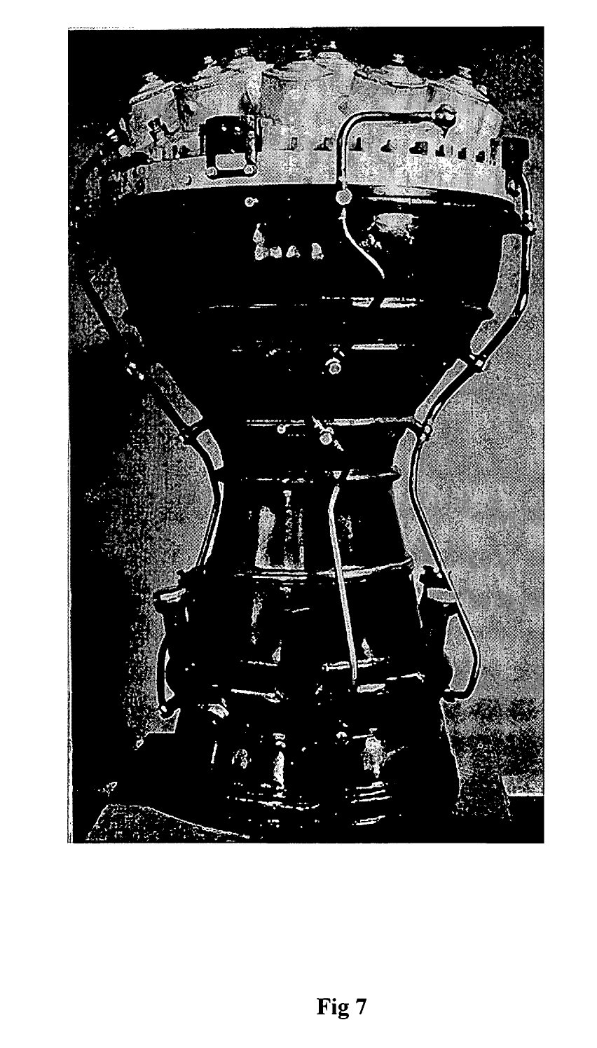

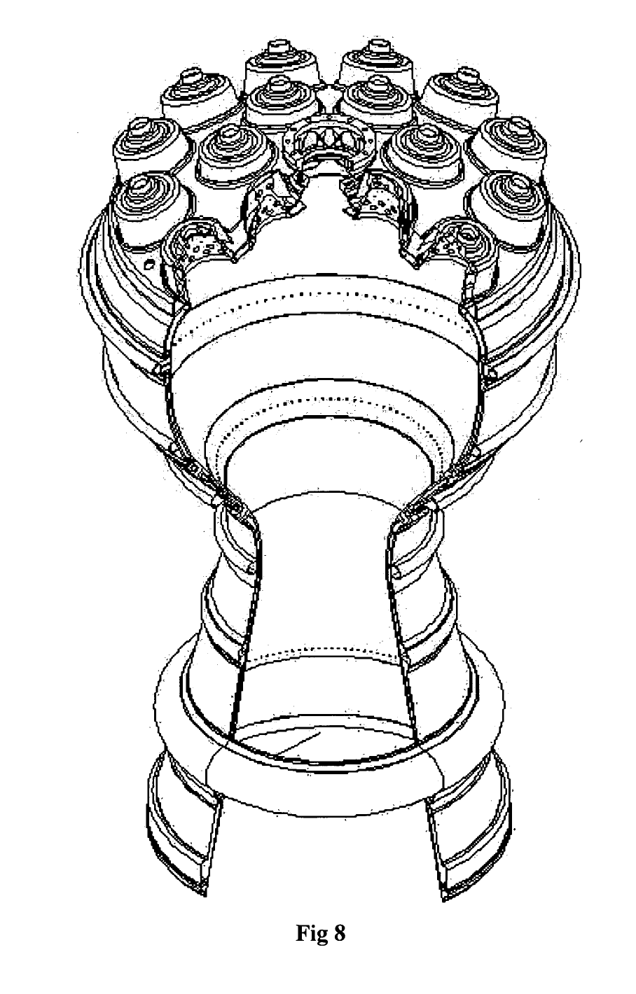

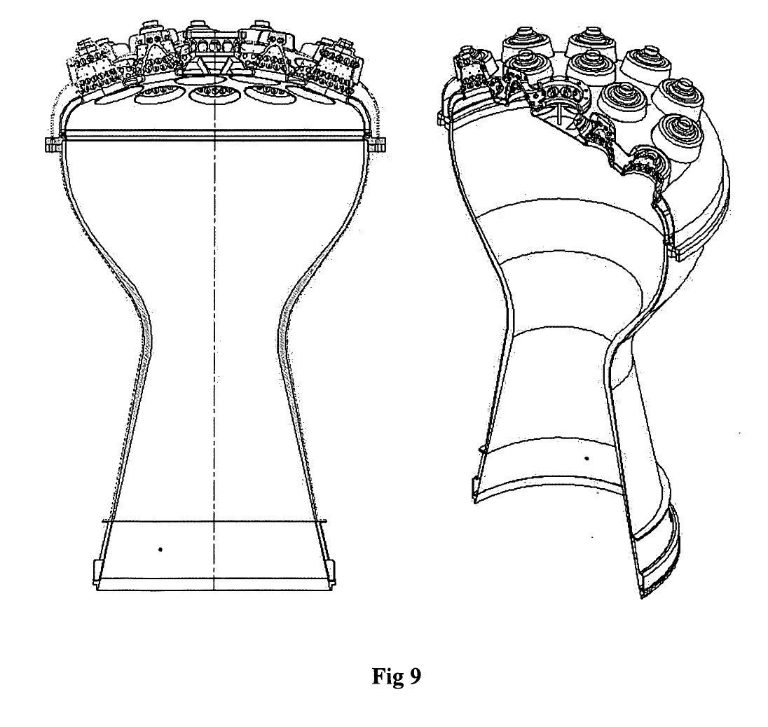

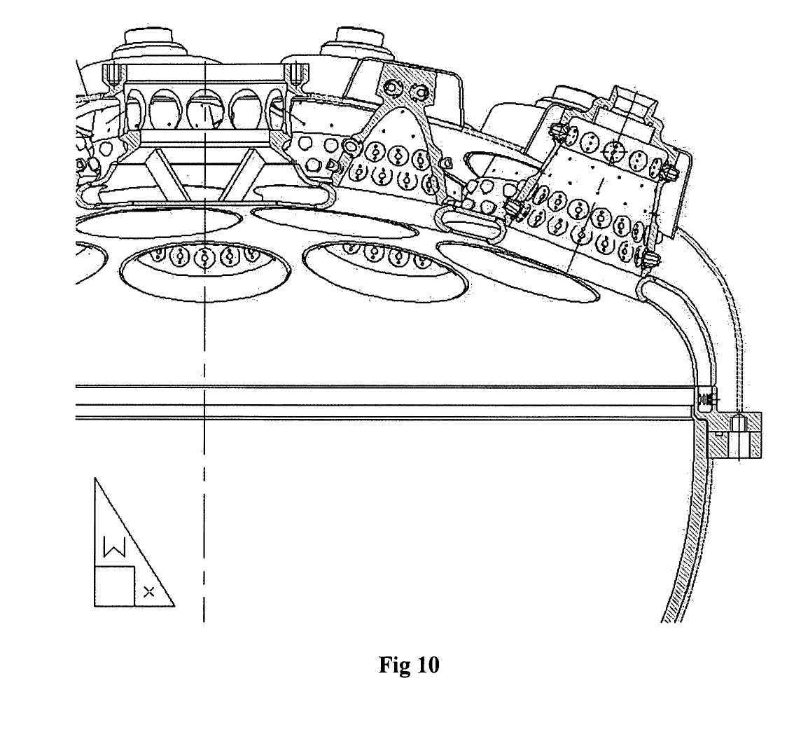

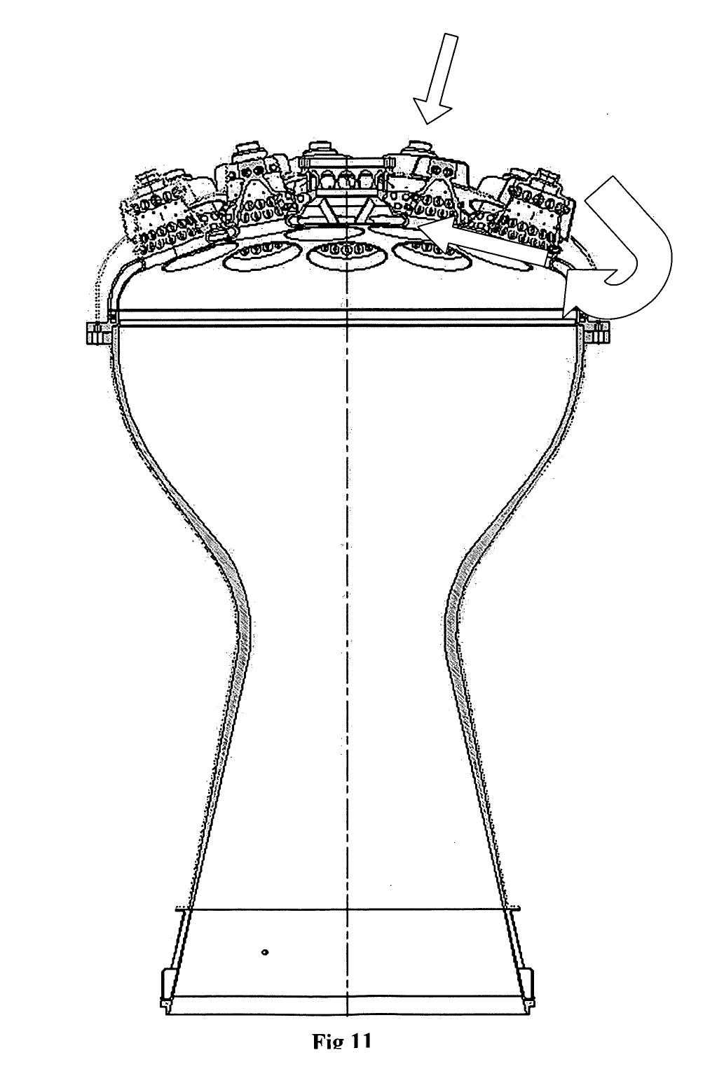

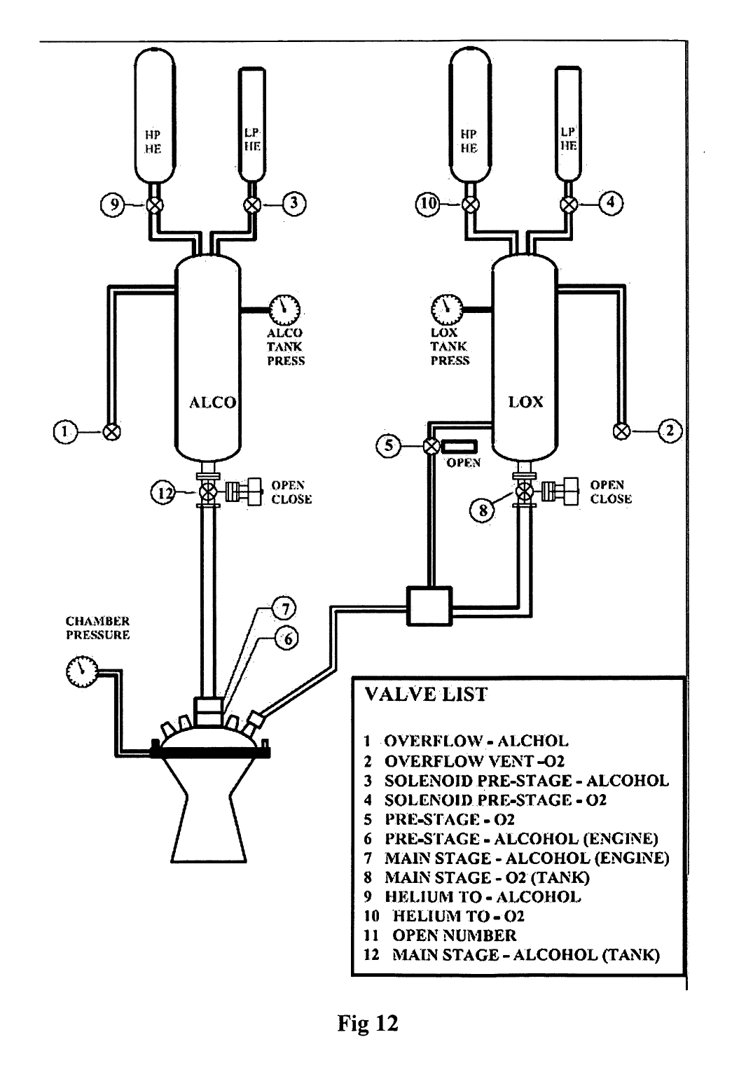

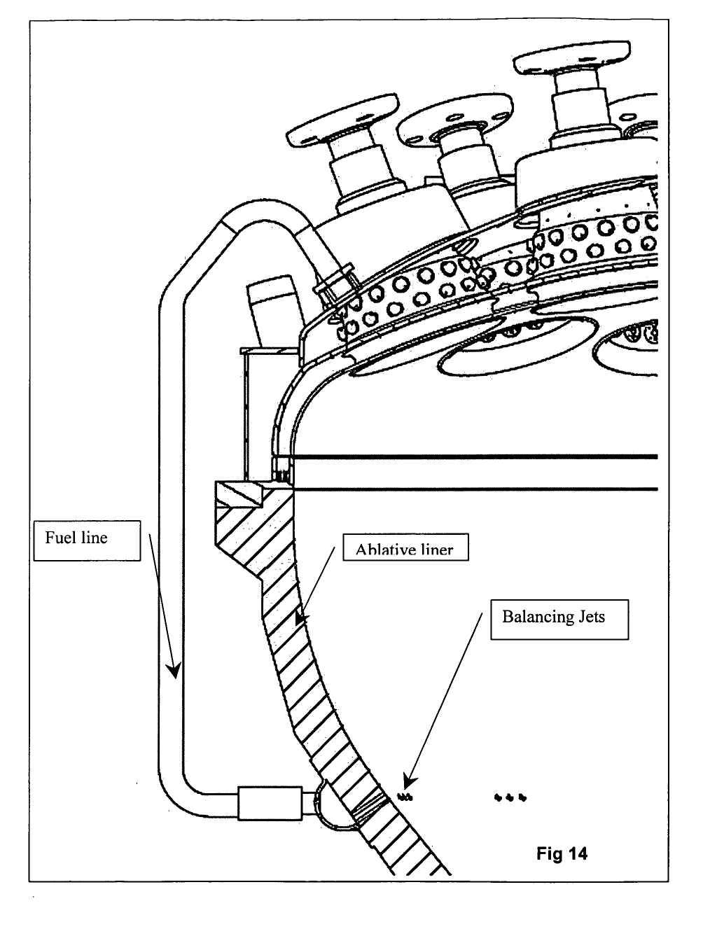

FIGS. 7-14 illustrate various aspects of a rocket engine for use in the present invention.

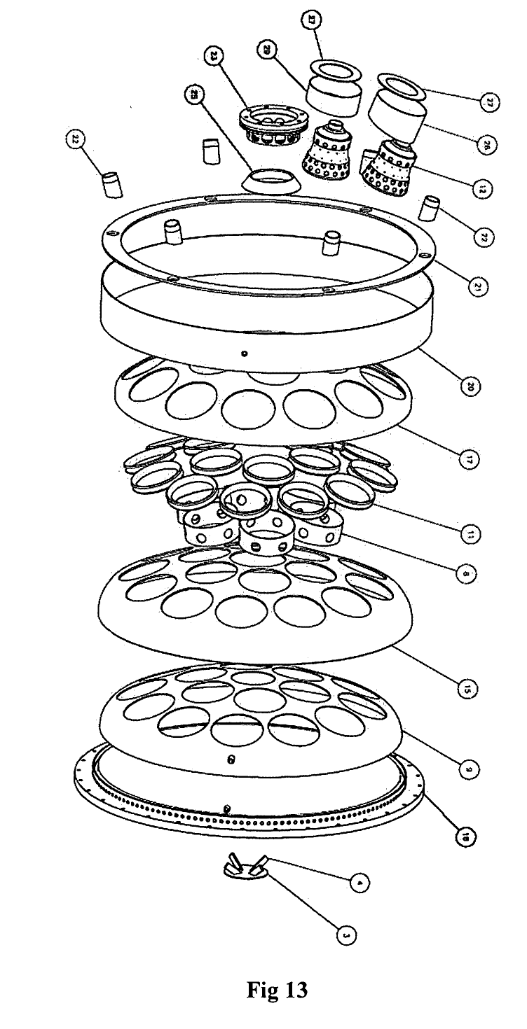

An exemplary injector fabrication procedure is discussed in this section. An injector of the present invention is shown in FIG. 13. An aluminum flange 18 is seal welded to the chamber dome 9 on the inside ring of the flange. The middle injector dome 15 is seal welded to the flange 18 on the outer ring of the flange. After this a set of cup rings 11 are welded to the upper and lower domes 9 & 15 to form a sealed double wall regenerative cooling passage for the dome. Central valve seat 23 is welded to the top of the fuel flow cone 25 and then complete assembly welded to the top of dome 15.

Burner cups 12 are welded to each of the cup rings 11 resulting in a continuous wall for the combustion chamber section. Then outside dome support rings 8 are stitch welded to the top of dome 15 surrounding each of the cups. Dome 17 is then placed over the burner cups and seal welded to the top of dome 15 and around the central valve seat 23. Covers 26 & 27 are welded on top of dome 17 completing the alcohol chamber inside the engine.

On the top of the main flange 18 the alcohol inlet manifold 20 & 21 are welded to form a chamber to distribute alcohol into the regenerative cooling space between domes 9 & 15. The alcohol inlets 22 are welded to the top of the alcohol inlet manifold 21. Vortex reducers 4 are welded to combustion chamber plate 3 and entire assembly is welded inside dome 9 to complete the injector assembly.

An exemplary ablative combustion chamber and nozzle fabrication procedure is discussed in this section. The combustion chamber and nozzle are manufactured from phenolic and epoxy impregnated fiberglass tape. Those skilled in the art would recognize them to be standard production methods. It is the application of an ablative liner to the A-4 aluminum injector with balancing jets and alcohol manifold that is unique to this invention. The usual production methods for this type of chamber and nozzle are as follows.

A two part mandrel with the profile of the combustion chamber and nozzle interior is assembled on a rotating jig. The mandrel is usually of two parts with the assembly joint at the narrow throat section. The jig is rotated while a bias ply phenolic impregnated tape is wound on the outside of the mandrel with edge of the tape perpendicular to the normal axis of the rocket engine. The tape is angled towards the nozzle exit area to provide for good wear resistance. Each thickness of tape is wound at different times with new angle of subsequent tapes being machined into the nozzle before next level is wrapped. The entire unit complete with mandrel is then put in an oven to cure were it becomes one part ready to be bolted to the injector flight.

From the foregoing, it will be seen that this invention is one well-adapted to obtain all the ends and objects herein above said forth together with other advantages which are obvious and which are inherent to the rocket engine design and use. It will be understood that certain features and sub combinations are of utility and may be employed without reference to the other features and sub combination. For example, a cluster of these engine could be fed from a central pump or pressuring system to increase efficiency of the vehicle tank system. Since many possible embodiments may be made of the invention without departing from the scope thereof, it is to be understood that all matter here and set forth are shown in the accompanying drawings is to be interpreted as illustrative and not in a limiting sense.

I claim:

1. A manned suborbital rocket comprising:
a nose cone;
a crew cabin operably connected to the nose cone; and
a rocket engine, the rocket engine employing the German A-4 (V-2) design.

2. The rocket of claim 2 further comprising a parachute recovery system to recover the rocket engine, the crew cabin, and the nose cone.

3. The rocket of claim 2 further comprising propellant tanks operably connected to the rocket engine, the propellant tanks having walls integral to an outer vehicle wall.

4. The rocket of claim 2 wherein the crew cabin is operable to carry humans into space.

5. The rocket of claim 2 having a size, the size being transportable by road and rail.

6. The rocket of claim 2 having a shape, the shape being the German A-4 (V-2) design.

7. A rocket engine comprising:
an injector;
a combustion chamber operably connected to the injector; and
a nozzle operably connected to the combustion chamber, the nozzle having an ablative liner;
wherein the injector, the combustion chamber, and the nozzle employ a German A-4 (V-2) rocket engine design.

8. The rocket engine of claim 7, wherein the injector is metal and has a base flange with a surrounding fuel manifold to bolt on the combustion chamber and the nozzle.

9. The rocket engine of claim 8, wherein the nozzle has a mounting flange to attach to the injector.

10. The rocket engine of claim 7, further comprising means for feeding propellants to the rocket engine by gas alone.

11. The rocket engine of claim 7, further comprising means for regeneratively cooling the nozzle.
